(19) United States
(12) Patent Application Publication
(10) Pub. No.: US 2017/0166455 A1
(43) Pub. Date: Jun. 15, 2017

(54) SOLAR POWERED THERMAL DISTILLATION WITH ZERO LIQUID DISCHARGE

(71) Applicant: Board of Regents, The University of Texas System, Austin, TX (US)

(72) Inventors: William S. Walker, El Paso, TX (US); Adrian Saenz, Richardson, TX (US); Hillery T. Kemp, Many, LA (US); John Manford, Cloudcroft, NM (US)

(73) Assignee: Board of Regents, The University of Texas System

(21) Appl. No.: 15/367,503

(22) Filed: Dec. 2, 2016

Related U.S. Application Data
(60) Provisional application No. 62/267,415, filed on Dec. 15, 2015.

(51) Int. Cl. C02F 1/14; C02F 1/16; B01D 3/14; B01D 3/00; B01D 3/02; C02F 1/06; B01D 3/06

(52) U.S. Cl. CPC C02F 1/14; C02F 1/06; C02F 1/16; B01D 3/065; B01D 3/007; B01D 3/02; B01D 3/146; C02F 2103/08

(57) ABSTRACT

A solar powered thermal distillation system and method includes a solar still having a first end and an opposite second end with a longitudinal access extending between the first end and the opposite second end, the solar still further having a raised side and an opposite lowered side with a width axis extending between the raised side and the opposite lowered side. A solar-transmitting roof is located atop the solar still, wherein the solar-transmitting roof admits solar energy to equipment maintained within the solar still. The solar sill also includes a heating surface inclined along a direction aligned with or parallel to the width axis so that water flows down the heating surface along or parallel with the width axis, and a tubular member extending below the heating surface between the raised side and the opposite lowered side.

### CROSS-REFERENCE TO PROVISIONAL APPLICATION

This nonprovisional patent application claims the benefit under 35 U.S.C. §119(e) and priority to U.S. Provisional Patent Application Ser. No. 62/267,415 filed on Dec. 15, 2015, entitled “Solar Powered Thermal Distillation With Zero Liquid Discharge,” which is hereby incorporated herein by reference in its entirety.

### TECHNICAL FIELD

Embodiments are related to the field of solar powered thermal distillation. Embodiments also relate to the use of multi-stage or multi-effect thermal distillation (such as, but not limited to, multi-stage flash, membrane distillation, multi-effect distillation, or vapor (re)compression) with solar as the energy source producing only pure water and dry salt from salty and saline source water. Embodiments further relate to a process for desalination, and more specifically, to a process for desalination involving a solar distillation still having a heating surface orientation designed to maximize solar energy capture and multiple modules of thermal distillation thereby enhance the yield of potable water in a desalination process.

### BACKGROUND

The global population is growing and its resource dependency is growing accordingly. More so, impoverished countries around the world have limited means to provide food and water to its inhabitants. The world has an abundance of water, however, only three percent of it is considered clean enough to drink. There is thus a continuing need to develop improved desalination technology, which could make use of the world's vast brackish and saline water resources.

Desalination is a process that removes minerals from saline water. Desalination also can involve the removal of salts and minerals from target substance such as in the case of soil desalination. During a desalination procedure, saltwater is desalinated to produce water suitable for human consumption or irrigation. Due to its energy consumption, desalinating sea water is generally more costly than using fresh water from rivers or groundwater, water recycling, and water conservation. However, these alternatives are not always available and depletion of reserves is a critical problem worldwide. Desalination is particularly relevant in dry areas such as in the American west, Australia, the Middle East, and Africa, to name a few areas, which traditionally have relied on collecting rainfall behind dams for water.

Solar distillation is a method of purifying water by harnessing the sun's energy. Solar distillation involves the use of solar energy to evaporate water and collect its condensate within the same closed system. Unlike other forms of water purification, solar distillation can convert salt or brackish water into fresh drinking water. The structure that houses the process is known as a solar still and although the size, dimensions, materials, and configuration are varied, all rely on a procedure wherein an influent solution enters the system and the more volatile solvents leave in the effluent leaving behind the salty solute behind.

Solar distillation is thus an effective technique for purifying seawater/brackish water because it can produce water as clean as, for example, 10 mg/L of total dissolved solids (TDS). Solar stills, however, have not been widely employed because the classic still only produces approximately 3 liters per day per square meter of solar capture. This poses a challenge since the amount of drinking water consumed per person is approximately 2 liters per day. Over time, other methods of water filtration have been developed. Reverse osmosis, for example, is currently the most popular method of desalinating water, but it is energy intensive and subject to high operating costs, which renders it unreasonable for insolvent regions.

FIG. 1 illustrates a schematic diagram of the basic thermodynamic operation of a prior art solar still. Solar distillation is an alternative for desalinating and sanitizing water using solar energy from the sun. The functioning of solar still is shown in FIG. 1. The “classic” solar still can vary geometrically from semispherical shapes to pyramids. The solar still includes a trough 14 and a basin 15. The trough 14 is responsible for collecting condensate. A basic solar distiller functions with the basin 15 filled with water 16 that is manually or automatically fed into the basin 15. The sunlight radiation strikes the bottom of the basin 15 where the water 16 is standing, and solar thermal energy heats the water 16 and increases vaporization. Arrows 10 shown in FIG. 1 indicates incoming solar energy.

As the water 16 evaporates, it leaves behind contaminants such as salt, bacteria, and other substances that compromise the water 16. Water vapor is shown in FIG. 1 as rising, as indicated by arrows 12. As the water vapor reaches the glass 13, heat escapes through the glass 13, leaving behind water vapor with low kinetic energy. As the air becomes saturated with moisture, water molecules begin to condense on the glass surface, which forms water droplets that travel to the trough 14. The trough is an apparatus that collects the water droplets and empties it into a container such as a bottle. Water distillers can purify a wide variety of water from brackish groundwater to seawater.

Attempts have thus been made to provide solar stills capable of producing relatively large quantities of potable water. These attempts have proven to be costly and inefficient and have failed at producing large quantities of potable water. Other desalination technology is complex, energy intensive, and delivers only low yield from feed water. Therefore, a need exists for an improved solar collection system combined with thermal distillation.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a solar collection system and method combined with thermal distillation.

It is another aspect of the disclosed embodiments to provide for the use of multi-stage or multi-effect thermal distillation (such as, but not limited to, multi-stage flash, membrane distillation, multi-effect distillation, or vapor (re)compression) with solar as the energy source producing only pure water and dry salt from salty and saline source water.

It is yet another aspect of the disclosed embodiments to provide for improved systems, devices, and methods for desalination.

It is a further aspect of the disclosed embodiments to provide for systems, devices, and methods for desalination involving a solar distillation still (“solar still”) having a heating surface orientation configured to maximize solar energy capture and multiple modules of thermal distillation, thereby enhancing the yield of potable water in a desalination process.

It is also an aspect of the disclosed embodiments to provide for a thermal powered solar distillation method and system based on a cycled arrangement, such as with day and night cycles, to further enhance the yield of potable water.

The aforementioned aspects and other objectives and advantages can now be achieved as described herein. In accordance with one example embodiment, an innovative solar can be implemented, which outperforms the production of the classic solar still. In such an example embodiment, a PVC return duct can be integrated into the system and/or apparatus to return cold air coming out of the top of the condenser to the base of the inclined thin film within the solar collector. The design of the cold air return duct provided natural, buoyancy-driven convection through the first effect to provide consistent and smooth air flow. This improvement results in more uniform and consistent temperature performance in the solar collector and the condenser, but most importantly, heat transfer through the wall of the duct allows water to condense inside the duct. Implementation of this duct improved the water production of the system by 20-30%. The flow rate can be modulated and controlled for efficient air flow through the system by at least one integrated valve.

In another example embodiment, a novel countercurrent flow system can be integrated into the solar system without an external PVC return duct. The disclosed advanced solar distillers have improved on the classic solar still by at least a factor of, for example, 3.

A variety of example embodiments are disclosed herein. For example, in one embodiment, a solar powered thermal distillation system can be configured, which includes a solar still having a first end and an opposite second end with a longitudinal access extending between the first end and the opposite second end, the solar still further having a raised side and an opposite lowered side with a width axis extending between the raised side and the opposite lowered side and at least one solar-transmitting roof atop the solar still, wherein the at least one solar-transmitting roof admits solar energy to electrical and/or electromechanical equipment maintained within the solar still. The solar still can be configured to include a heating surface inclined along a direction aligned with or parallel to the width axis so that water flows down the heating surface along or parallel with the width axis. The solar still can further include a tubular member that extends below the heating surface between the raised side and the opposite lowered side. The solar still can also include one or more collection troughs positioned to receive condensed water dripping from the tubular member.

In another example embodiment, the aforementioned solar still can include a liquid distributor positioned along the raised side of the heating surface to distribute water discharged from the liquid distributor substantially across a length of heating. In some example embodiments, the energy recovered in the solar still can be provided in the form of heated water delivered to a vessel operated under a vacuum.

In some example embodiments, the aforementioned vessel can include the tubular member and the collection trough (or troughs) to collect condensate dripping from the tubular member. In another example embodiment, the vessel can be enclosed within an exterior vessel that is also maintained under a vacuum condition such that the vessel comprises an interior vessel maintained within the exterior vessel. In some example embodiments, water that does not flash can be transferred to another vessel operated at a greater vacuum for further flashing.

In yet another example embodiment, the aforementioned interior and exterior vessels can be configured with a pair of internal and external containment vessels in association with the tubular member and the at least one collection trough to recover condensed water, wherein the pair of internal and external containment vessels constitute a one stage/effect and a multiple stages/effects, each with greater vacuum or temperature, which are combinable to produce pure water at each of the multiple stages/effects.

Water heated in the multiple stages/effects can be used to condense flashed water vapor in earlier and hotter stages and routed through the solar still to a first stage. Additionally, cold water heated in the tubular member can be stored in the vessel, and the vessel can include (in some example embodiments) a transparent canopy with sloped roof. The transparent canopy can be configured with, for example, a plurality of troughs for collecting purified water.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic diagram of the basic thermodynamic operation of a prior art solar still;

FIG. 2 illustrates a three-dimensional view of a solar still apparatus, which can be implemented in accordance with a preferred embodiment;

FIG. 3 illustrates a sample image of a GUI (Graphical User Interface) in accordance with an example embodiment;

FIG. 4 illustrates a schematic diagram of a system composed of an arrangement of thermocouples, humidity sensors, and conductivity cells, in accordance with an example embodiment;

FIG. 5 illustrates a pictorial diagram of a cold-air return duct, which can be implemented in accordance with an example embodiment;

FIG. 6 illustrates a water production comparison chart, in accordance with an example embodiment;

FIG. 7 illustrates a solar collector air vent, in accordance with an example embodiment;

FIG. 8 illustrates a graph depicting data indicative of heat loss through a double-pane glass, in accordance with an example embodiment;

FIG. 9 illustrates an image of an evaporator glass 150, which may be implemented in accordance with an example embodiment;

FIG. 10 illustrates an image of a condenser coil 160, which can be implemented in accordance with an example embodiment;

FIGS. 11A-11B illustrate graphs indicative of sample day-cycle performance (April 4), in accordance with an example embodiment;

FIGS. 12-12B illustrate graphs indicative of sample day-cycle performance (April 6), in accordance with an example embodiment;

FIGS. 13A-13B illustrate graphs indicative of sample day-cycle performance (April 11), in accordance with an example embodiment;

FIGS. 14A-14B illustrate graphs indicative of sample day-cycle performance (April 19), in accordance with an example embodiment;

FIGS. 15A-15B illustrate graphs indicative of sample day-cycle performance (April 26), in accordance with an example embodiment;

FIGS. 16A-16B illustrate graphs indicative of sample day-cycle performance (April 27), in accordance with an example embodiment; and

FIG. 17 illustrates a block diagram of a solar powered thermal distillation system, in accordance with an example embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. For example, preferred and alternative embodiments are disclosed herein.

Additionally, like numbers refer to identical, like, or similar elements throughout, although such numbers may be referenced in the context of different embodiments. As used herein, the term “and/or” includes any and all combinations of one or more of the associated listed items.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

On our globe today, there are regions on the earth where people have water sources, but no means of purifying it before consumption. Moreover, infrastructure in these areas limit the use of electric powered purifying methods leaving them to drink unclean water. It is therefore deemed necessary to ensure the unit produced be as electrically independent as possible, and with a low manufacturing and implementation cost. Therefore, it is considered a vital part of the disclosed embodiments and any variations thereof to maintain low costs for it to be considered a viable solution.

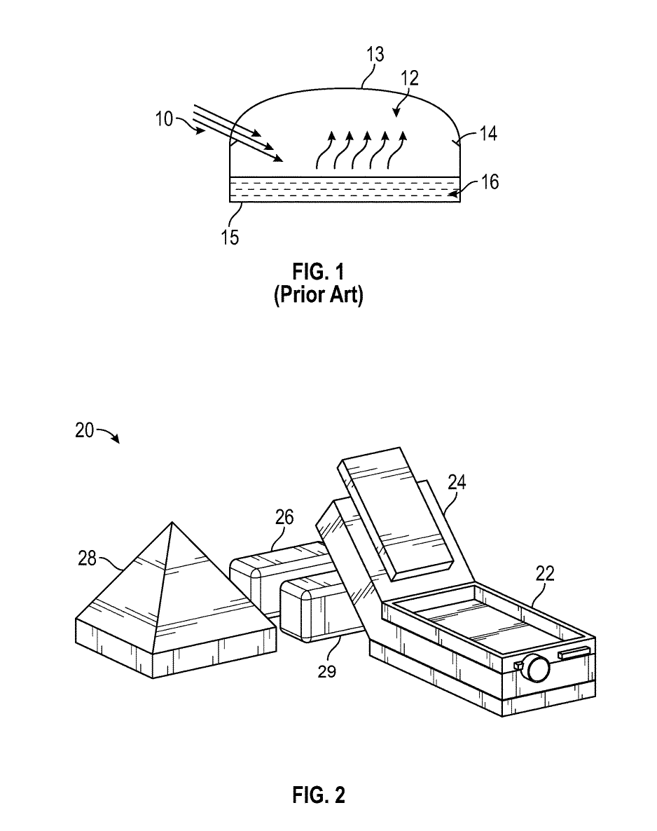

FIG. 2 illustrates a three-dimensional view of a solar still 20, which can be implemented in accordance with a preferred embodiment. As will be discussed in greater detail herein, a variety of embodiments can be implemented, which vary in scope from one another, but which achieve the viable solution referred to above. In some example embodiments, two stages configured in series, known as “effects,” can be implemented. The first effect absorbs energy during the day and utilizes a heat exchanger for the condensing process. The energy gained from the heat exchanger can then be transferred to the second effect as a heat source to produce evaporation for condensate during night hours. Water in the second unit loses heat during night time so the cooled water from the second unit can be utilized again in the heat exchanger during the day time to produce condensate, and the cycle can then repeat. This dual effect unit has shown significant advances over the standard still and yet has potential room for even greater improvements.

In the configuration shown in FIG. 2, the system or solar still 20 includes a solar collector 22 with respect to a condenser 24. A second effect 28 is also depicted in FIG. 2 (i.e., the pyramid-shaped structure shown in FIG. 2). Insulated components 26 and 29 are also illustrated in in FIG. 2.

The disclosed embodiments can be implemented in, for example, three phases as follows: (i) data acquisition deployment; (ii) preliminary analysis and optimization; and (iii) design improvements.

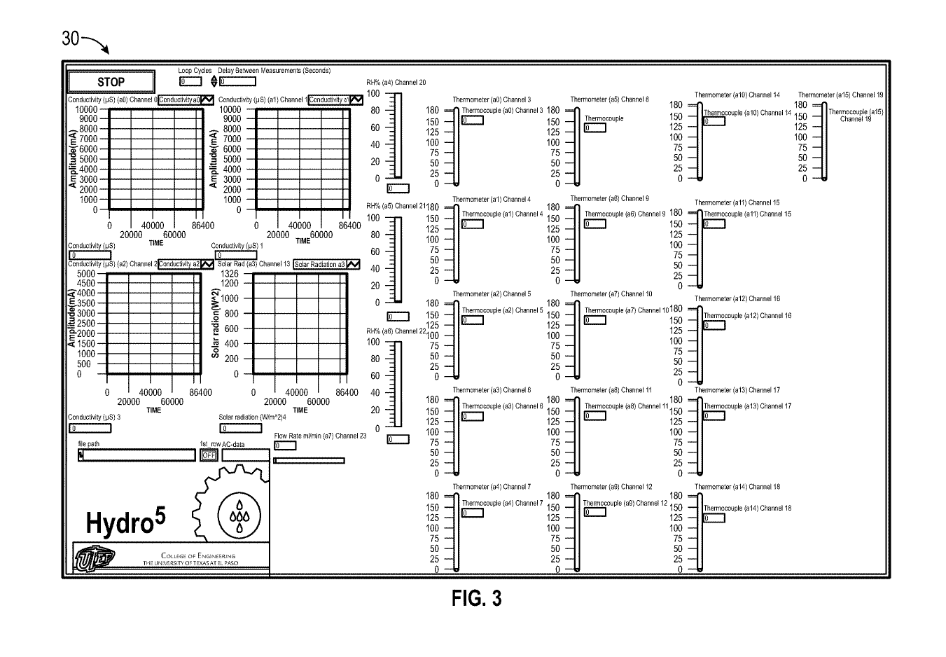

Regarding data acquisition deployment, a data acquisition (DAQ) system can be implemented using, for example, National Instruments LabVIEW to automatically record the thermodynamic performance of a solar still such as the solar still or system 20 shown in FIG. 2. For analysis of the thermodynamic efficiency of the still, a pyranometer can be used to measure the cumulative solar energy. In addition, thermocouples and humidity sensors can be installed at strategic locations, and a liquid flow meter was installed to monitor the chill flow with respect to, for example, the condenser 24 depicted in FIG. 2. Data from such sensors can enable calculations of enthalpy throughout the distiller. It should be noted that an analysis of the unit's ability to remove salinity is also important, and this can be accomplished by measuring the conductivity of the raw water and distilled water. A GUI (Graphical User Interface) such as a VI (Virtual Interface) can be utilized to provide a user-friendly interface with real time signal measurements which the user can initiate, observe all sensors, save, and shutdown the program. A screen-capture of an example VI interface is depicted is shown in FIG. 3. That is, FIG. 3 illustrates a sample image of a GUI (Graphical User Interface) 30, in accordance with an example embodiment.

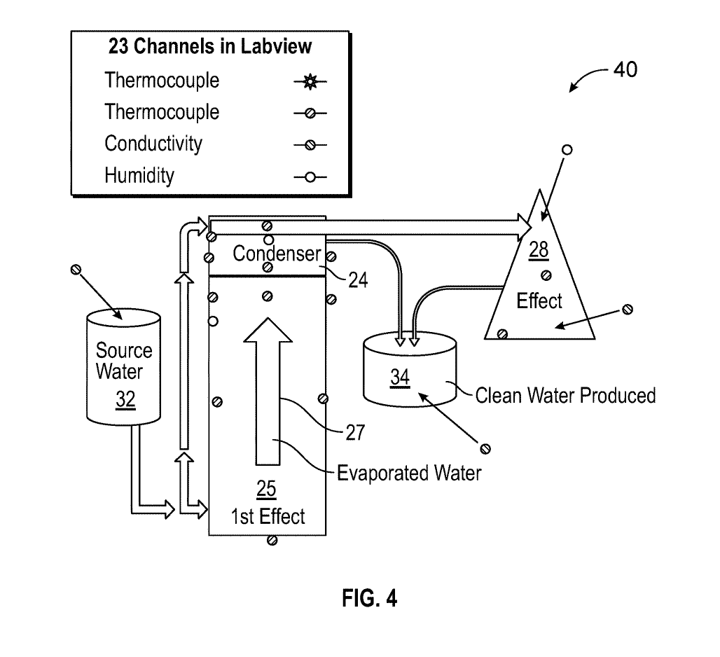

FIG. 4 illustrates a schematic diagram of a system 40 composed of an arrangement of thermocouples, humidity sensors, and conductivity cells, in accordance with an example embodiment. The solar still or solar still system 40 shown in FIG. 4 includes a 1st effect solar collector 25 that produces evaporated water with respect to a condenser 24. A water source 32 supplies water to the first effect 25. A second effect 28 is also shown in FIG. 4 with respect to the condenser 24, and the 1st effect solar collector 25. FIG. 4 further illustrates the resulting clean water 34 produced.

Regarding sensor placement, a pyranometer, one or more thermocouples, one or more humidity sensors, and one or more conductivity cells can be installed throughout the solar still and/or the solar still system 40. In an experimental embodiment, for example, a pyranometer depicted via a sun symbol can be located twenty feet away from the solar still to avoid shadows. Six thermocouples can be placed inside the solar collector of the first effect 25 to observe spatial variability in moist-air flow. Another thermocouple can be placed away from the system to measure ambient temperatures. An additional six thermocouples can be installed in the condenser to observe spatial variation in air movement. The remaining two thermocouples can be located within the second effect 28 to measure the temperature of the liquid and the internal ambient environment of the effect. Three relative humidity sensors can be located within the prototype: the solar collector of the first effect 25, the condenser of the first effect 25, and in the second effect 28. Three conductivity sensors can be located in: (1) the source water 32, (2) first effect distillate water, and (3) the second effect 28.

The following are example data acquisition devices and sensors that can be implemented in the context of the experimental embodiment described above:
Qty-1 National Instruments eDAQ-9172 Compact DAQ Chassis: this component supports up to eight C Series I/O modules which, in conjunction with the modules, aid in data acquisition and provide power to support modules as well as common reference grounds.
Qty-1 National Instruments NI 9203 DAQ Module: this component is a support module for the chassis described above which possesses an 8-channel ±20 mA input which supports various sensors.
Qty-1 Micronta 12V Regulated Power Supply: provides power to all various sensors and modules.
Qty-1 Apogee SP-214 amplified 4-20 mA pyranometer: this instrument measures the total solar shortwave radiation in W m⁻².
Qty-1 National Instruments NI 9211A DAQ thermocouple module: this component is designed especially for 16 thermocouples.
Qty-100 ft K-Type thermocouple wire: these components measure the temperature in the ambient and internal environments of the prototype unit; the wire was cut into 16 individual thermocouple sensors.
Qty-3 George Fischer Conductivity Sensors with accompanying support Universal J Boxes: these components perform conductivity measurements ranging from 0-200,000 μS/cm.
Qty-3 Omega HX92 AC-RP1 humidity sensors with probes: these sensors provide relative humidity data within the ambient and internal environments of the prototype unit.
Qty-1 Omega HHF11A handheld air flow meter: provides air flow measurements in various areas on the prototype unit.
Qty-1 Omega FLR1011-D water flow meter: provides liquid flow rate data logging for the condenser inlet.

It can be appreciated that the various components and sensing devices described above are presented herein for illustrative purposes only and do not constitute limiting features of the disclosed embodiments.

Testing the solar still involved two test cycles, a day cycle and a night cycle. The day cycle testing was performed with mostly clear skies in order to record and analyze the still's performance under good conditions. Tests were performed at the Kay Bailey Hutchison desalination plant in El Paso, Tex. Untreated brackish water (approximately 2500 mg/L) was used as the source water. (As these tests lasted a maximum of 36 hours, the effects of mineral scaling were not observed in the first or second effects.)

For the day cycle, a tank filled with brackish water was used as the source feed for the first effect floor circulation and condenser chill fluid. Flow rates through the condenser were limited to a maximum of 0.81 mL/min due to the storage capacity of the insulated reservoirs. The solar collector of the first effect regularly adjusted constantly to maintain an orthogonal relationship to the sun at all times. The base of the still can rotate and the unit can incline up to 75 degrees from horizontal. Lastly, the LabVIEW program was set to record data at one minute intervals.

For the night cycle, a pump is used to feed the hot water from the day cycle (stored in the insulated reservoirs) into the second effect and back into the insulated reservoirs. At the end of the night cycle, the remaining, unevaporated water was recycled for the following daytime cycle.

While testing the prototype on a cold morning, the team visually observed random movement of water vapor in the solar collector. The team realized that the prototype was designed to rely on natural convection inside the solar still to transport humid air to the condenser above, but it seemed to be limited by random, chaotic air movements. Also, cold air inside the condenser descends, preventing the evaporated water from reaching the condenser, and in some cases, simply producing horizontal swirling motion inside the solar collector.

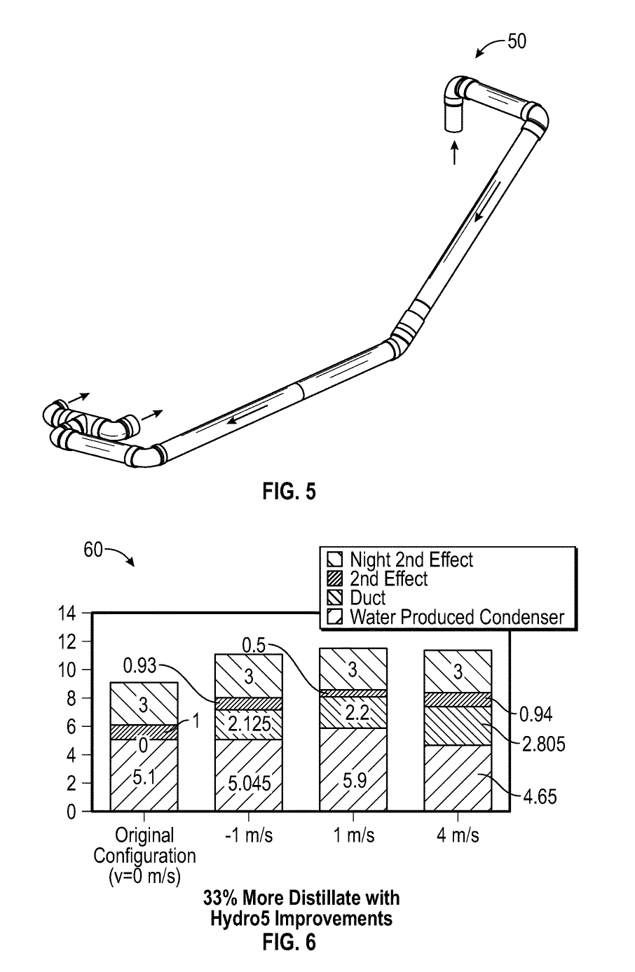

In order to solve this problem, a four-inch PVC return duct was developed to return cold air coming out of the top of the condenser to the base of the solar collector. The design of the cold air return duct provided natural (buoyancy-driven) convection through the first effect to provide consistent and smooth air flow. This improvement resulted in more uniform and consistent temperature performance in the solar collector and the condenser, but most importantly, heat transfer through the wall of the duct allowed water to condense inside the duct. Implementation of this duct improved the water production of the system by 20-30%. It was calculated that the amount of heat loss throughout the duct was around 50 W. FIG. 5 illustrates a pictorial diagram of the cold-air return duct 50 described above, which can be implemented in accordance with an example embodiment.

To study the effects of cold-air return duct, tests were performed in three stages: (1) original, no cold air recirculation duct; (2) natural (buoyancy-driven) convection with a cold air return duct; and (3) and fan-forced convection through the return duct. A list of a comparison of total system distillate production is shown in graph 60 in FIG. 6 as a function of air velocity in the return duct. Natural convection produced a duct air speed of approximately 1 m/s, and in one test, air flow was restricted to 0.1 m/s. A fan was used inside the duct to force an air speed of approximately 5 m/s.

TABLE 1
Summary of experiments with modified air-recirculation

| | | Return Duct | Total Solar | Daytime | Night time | Total |
|---|---|---|---|---|---|---|
| | | Air Velocity | Radiation | Distillate | Distillate | Production |
| Date of Run | Configuration | (m/s) | (W/m²) | (L) | (L) | (L) |
| April 4^{th} | Original KII | 0 | 6.2 | 2.5 | — | — |
| | configuration | | | | | |
| April 6^{th} | Natural | 1 | 6.7 | 4.3 | — | — |
| | convection | | | | | |
| April 11^{th} | Original KII | 0 | 7.6 | 5.4 | 3.0 | 8.4 |
| | configuration | | | | | |
| April 19^{th} | Natural | 1 | 8.1 | 8.2 | 3.0 | 11.2 |
| | convection | | | | | |
| April 26^{th} | Fan-forced | 5 | 7.5 | 8.0 | 3.0 | 11.0 |
| | convection | | | | | |
| April 27^{th} | Throttled | 0.1 | 8.0 | 7.2 | — | — |
| | convection | | | | | |
| May 29^{th} | Natural | 1 | 7.9 | 6.7 | — | — |
| | convection | | | | | |

Overall, the system operating with natural convection produced the maximum total distillate in a 24 hour cycle, which was an improvement approximately 30% compared to the original configuration of the prototype still.

To compare the overall efficiencies, the overall efficiency is taken from two 24 hour data cycles. One data cycle consists of its original setup and the other data cycle is with improvements implemented by Hydro5. The first data is from April 11 (Day 1) which was in its original setup. On this day, the first effect was run for a total of 10.75 hr, collected an estimated 10.62 kWh, produced a total of 5.4 L of distillate, and the condenser removed a total of 4.27 kWh. The efficiency of the first effect system in its original configuration is η=4.27/10.62=40%.

The second set of data is from April 19 with the addition of a cold air return duct. On this day, the first effect was operated for a total of 11.5 hrs, collected an estimated 11.3 kWh, produced a total of 8.15 liters of distillate, and the condenser removed a total of 8.98 kWh. With the addition of the duct, this brought the efficiency of the system to η=8.98/11.3=80%. Based on these data, the implementation of the duct doubled the efficiency of the system.

The solar collector area is 1.4 m is the area on the first effect that collects solar energy. (Note that the energy input from the pump is omitted from the overall system efficiency calculation due to the fact that the pump provided by Suns River/KII Inc. can be substituted by a lower power pumps.)

Regarding the efficiency of latent heat recovery, first, the efficiency was calculated from data collected on April 11 which was in its original configuration. The efficiency for the total solar still system including first and second effect was 52.5%. The second efficiency was calculated on April 19 with the implementation of the cold air return duct and was calculated at 64.6%. This was an improvement of 23% on the entire solar distiller system. This calculation was done by multiplying the total mass of distillate water produced by the entire system by the heat of vaporization of water by the total amount of solar energy.

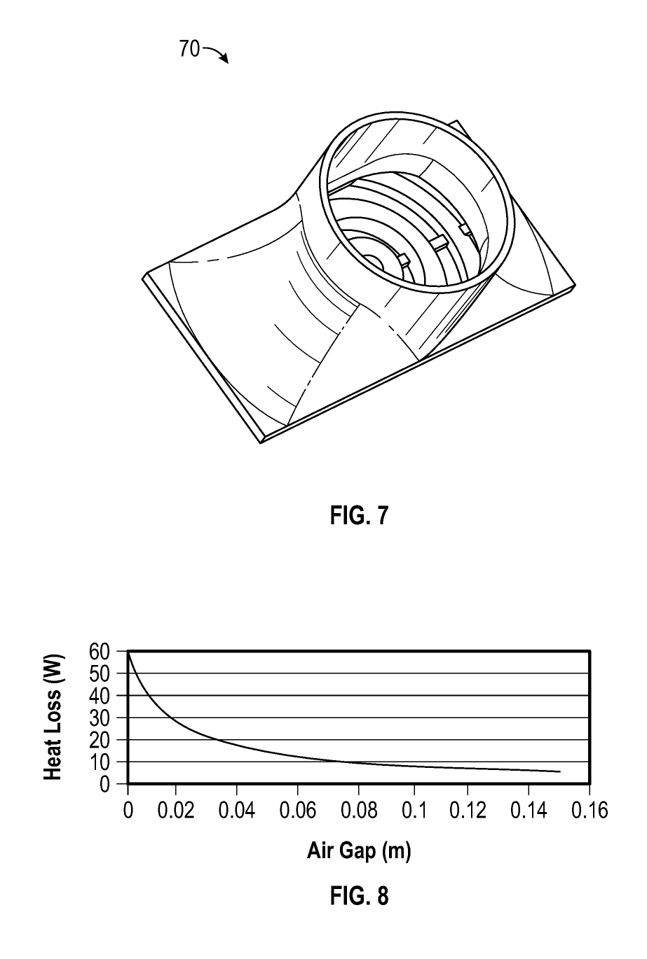

In order to improve the distribution of air from the return air duct at the base of the solar collector, two air vents were designed to be placed at the end of the duct. The design was made using SolidWorks software and printing them out at the UTEP Mechanical Engineering Machine Shop with rapid prototyping 3-D printing. The vent foils are designed to be at an angle to allow a better distribution throughout the solar collector. FIG. 7 illustrates one example of a solar collector air vent 70, which can be implemented in accordance with an alternative embodiment.

In order to increase efficiency and productivity produced by the 2nd effect pyramid, we implemented a black cloth to the bottom of it, so it can behave as a black body itself. By doing so the pyramid can collect more solar energy, which translates into higher temperature, humidity, and higher water production by this element alone. The amount of distillate produced before this improvement was 1 liter during the day cycle and three liters during the night cycle. With the black body floor, we were able to produce 1.5 liters during the day cycle. This is a 50% increase for the day cycle. The night cycle didn't get affected by this improvement, in both occasions we were able to produce 3 liters during the night.

The solar collector of the first unit is insulated utilizing a double pane glass. Solar energy passes through the glass and serves as an insulator to keep heat in. Currently the air gap is approximately 5 cm. Resistance modeling was used to calculate the heat loss through the double pane system, as shown in graph 80 of FIG. 8. The optimal air gap depends on how well the sides are insulated and how much material would be available to provide an air gap. This figure should serve as guide for further research to avoid losing energy through the solar collector.

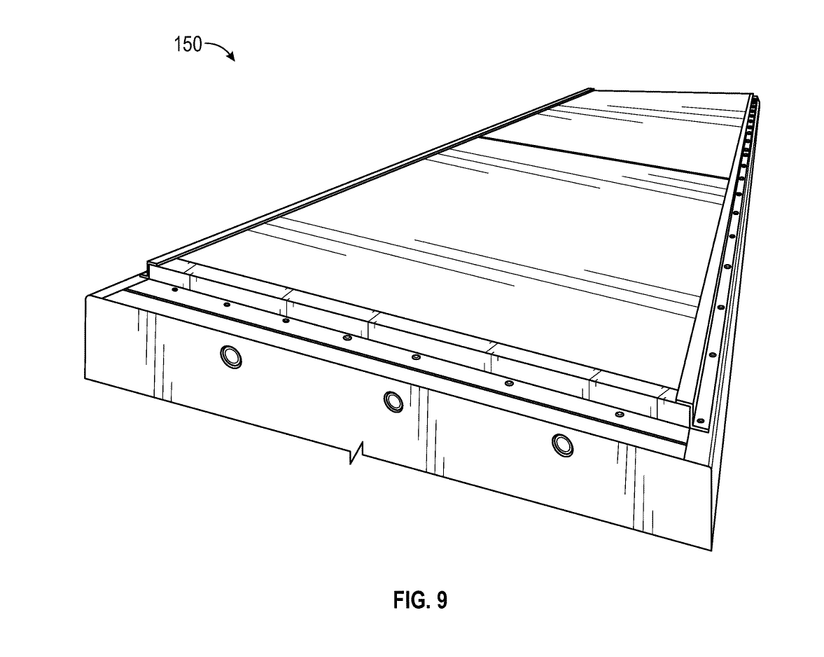

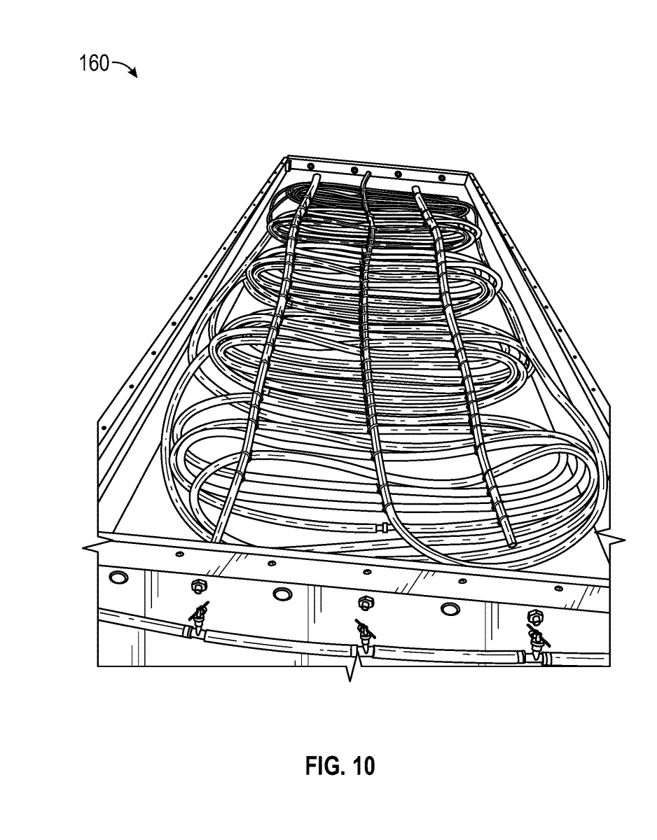

FIG. 9 illustrates an image of an evaporator glass 150, which may be implemented in accordance with an example embodiment. FIG. 10 illustrates an image of a condenser coil 160, which can be implemented in accordance with an example embodiment

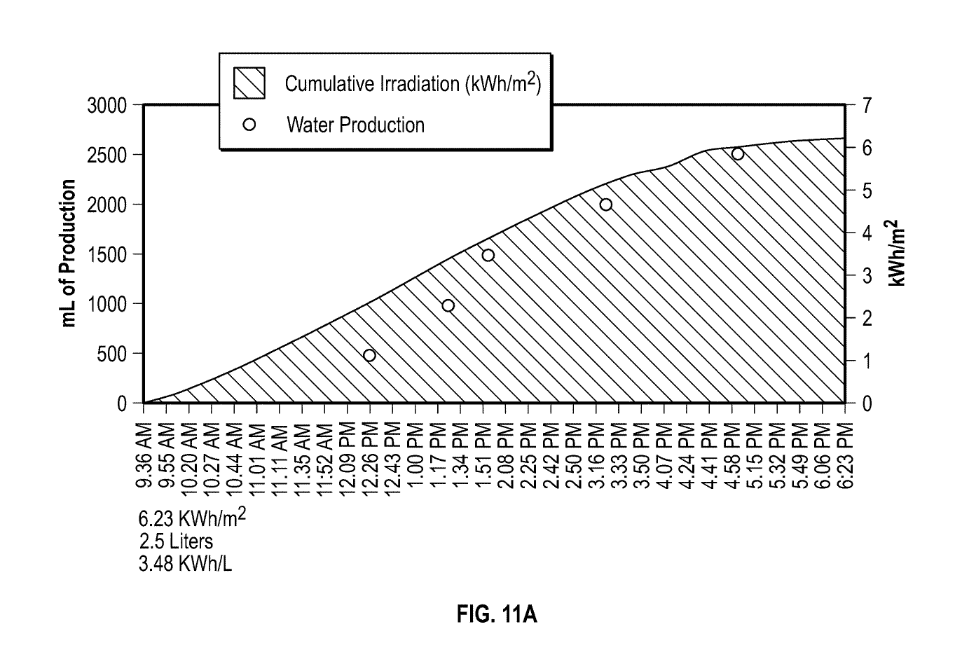

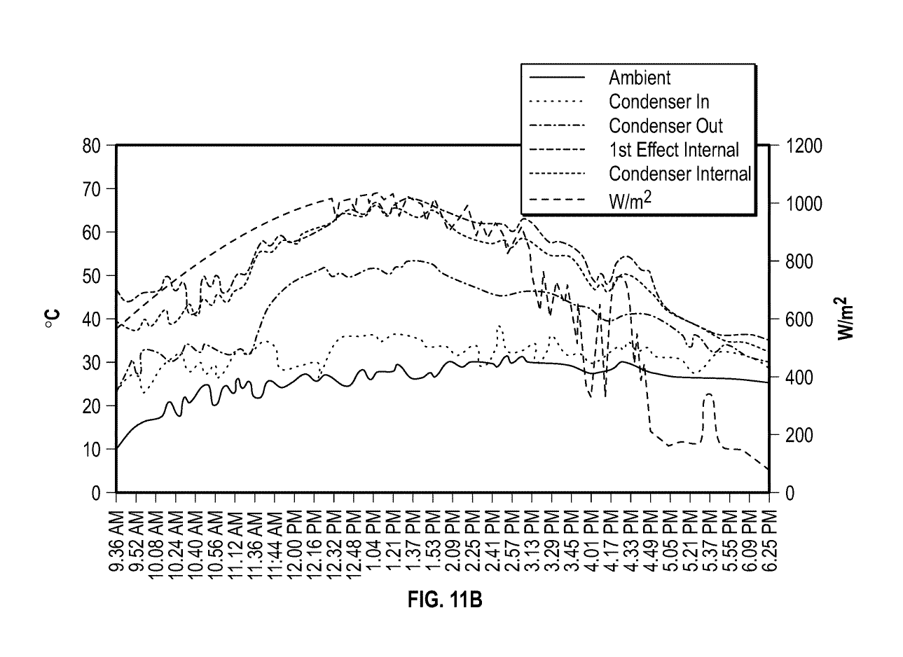

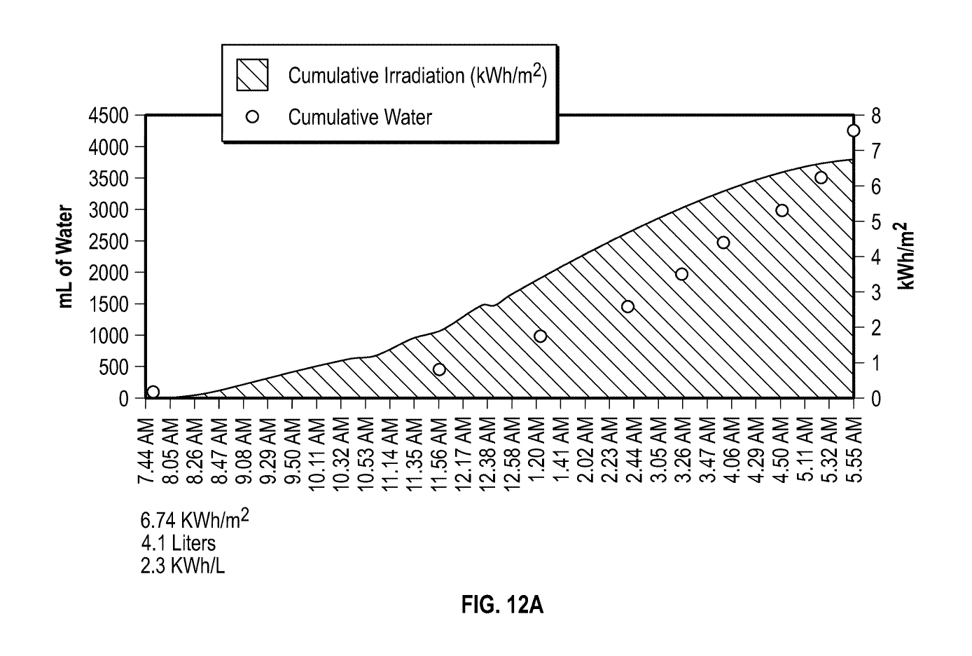

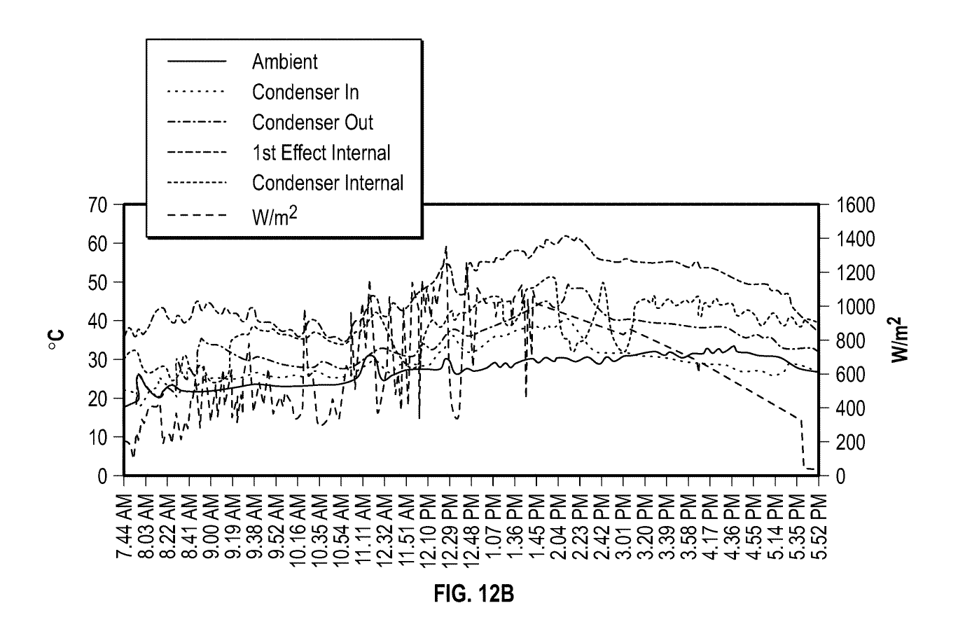

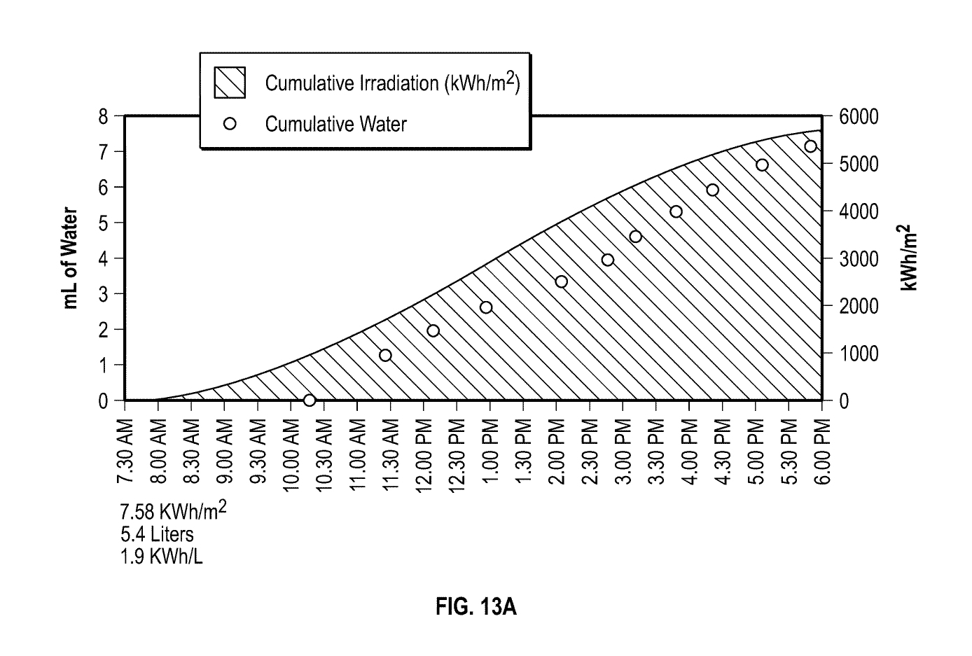

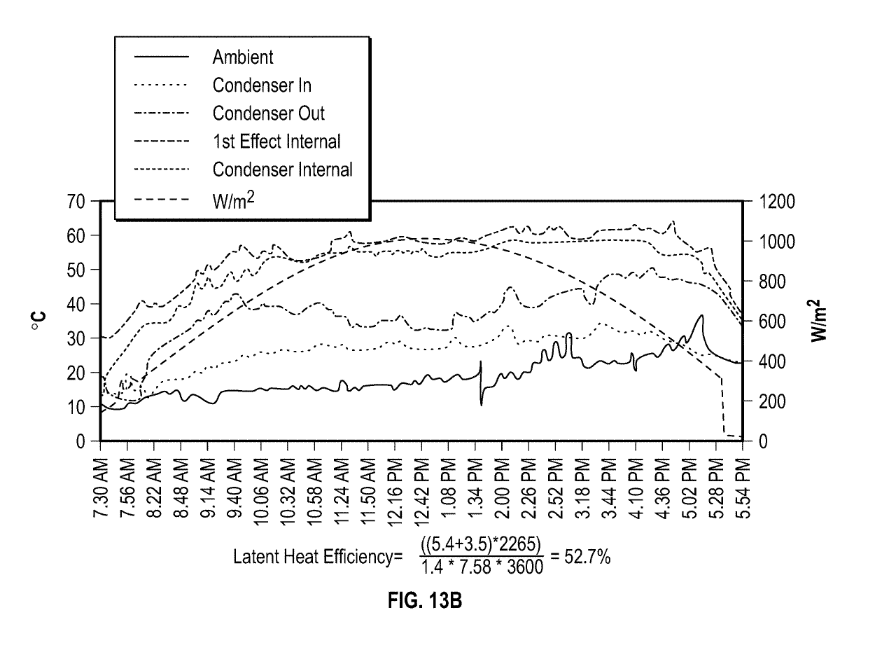

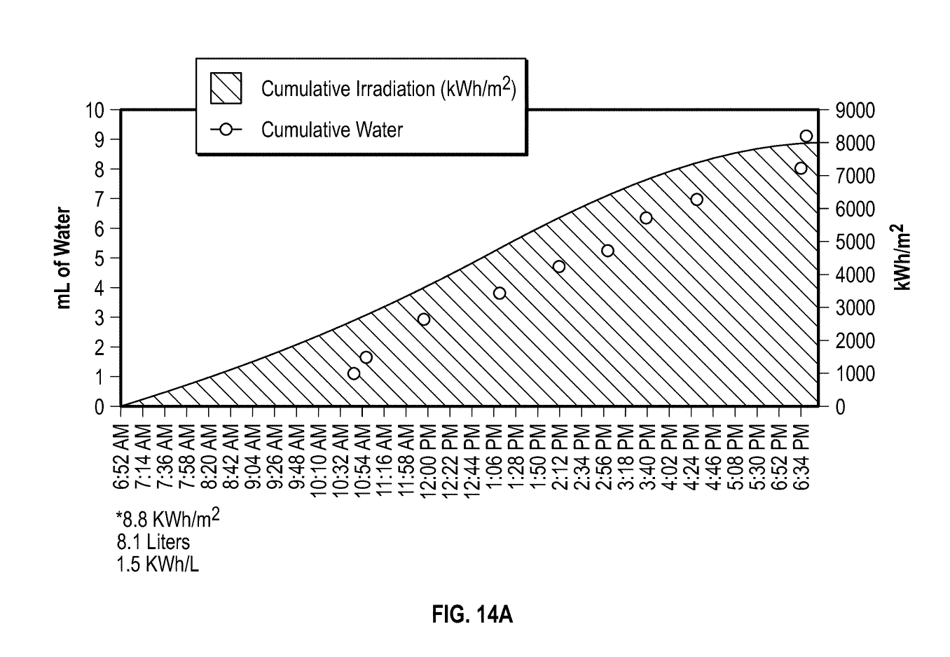

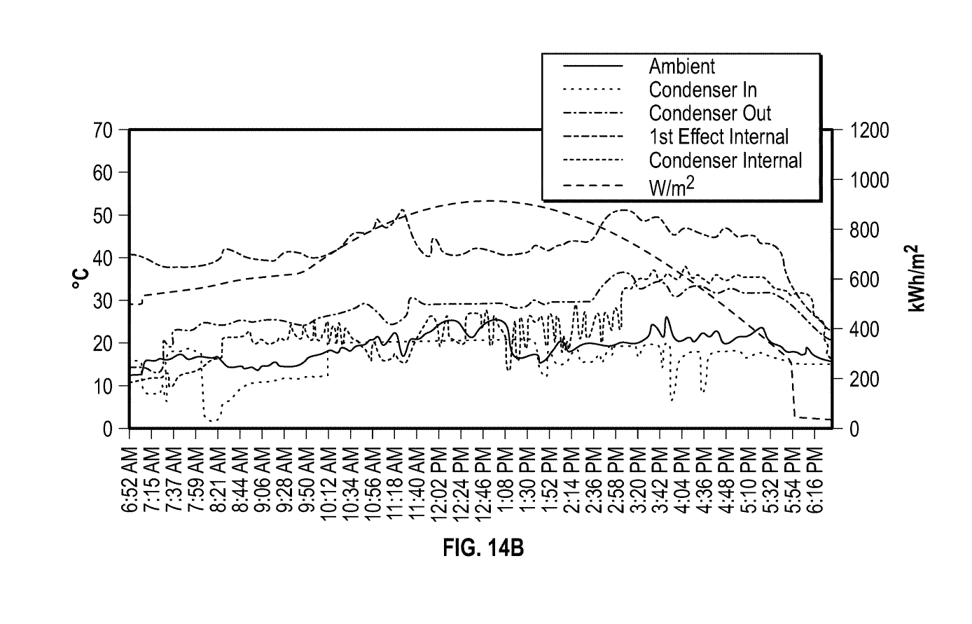

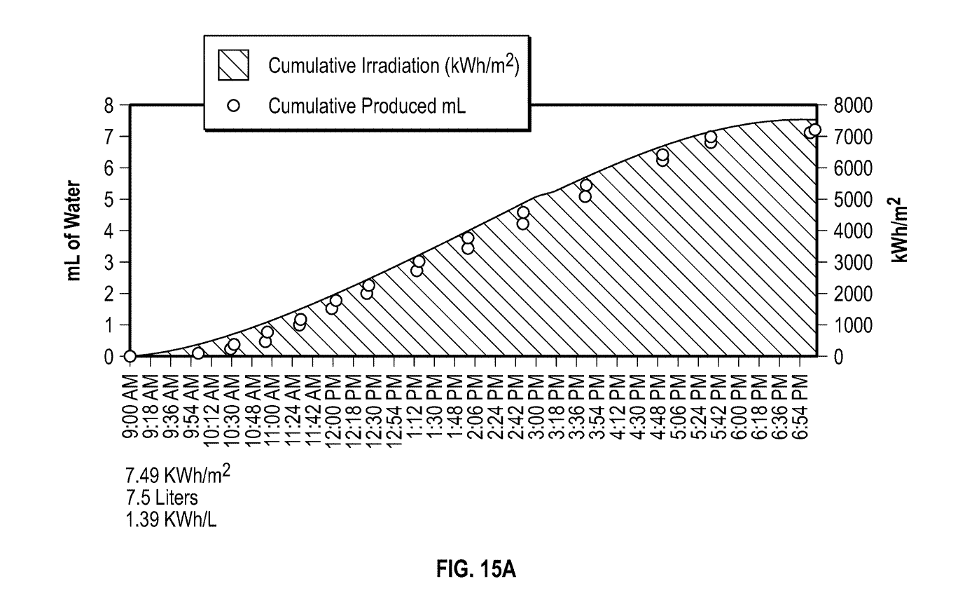

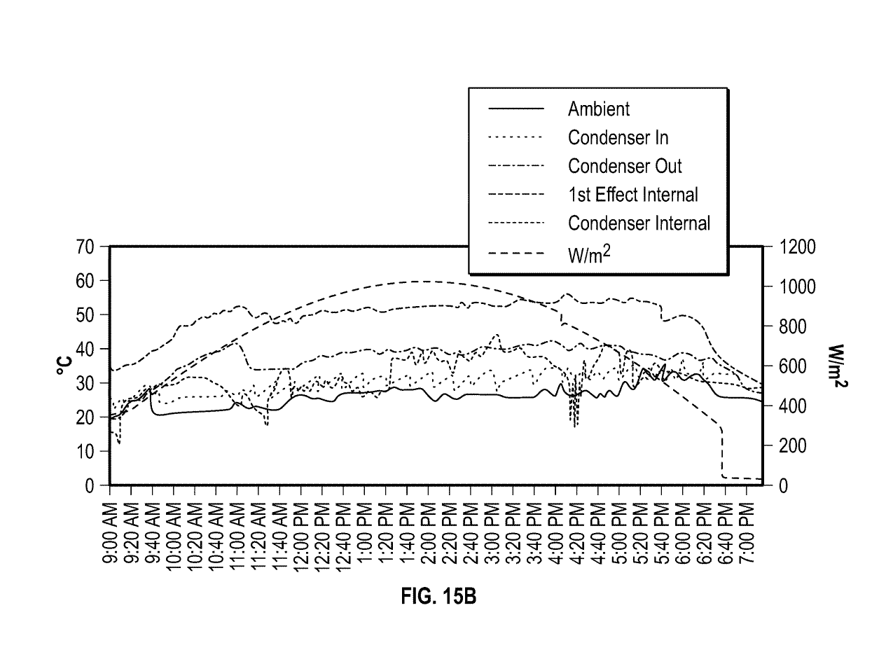

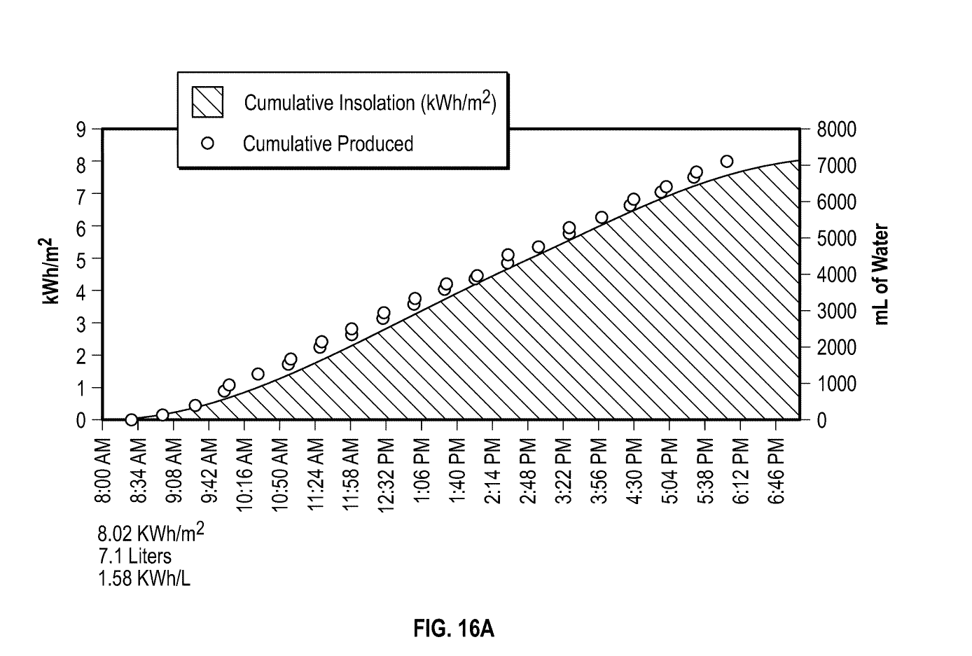

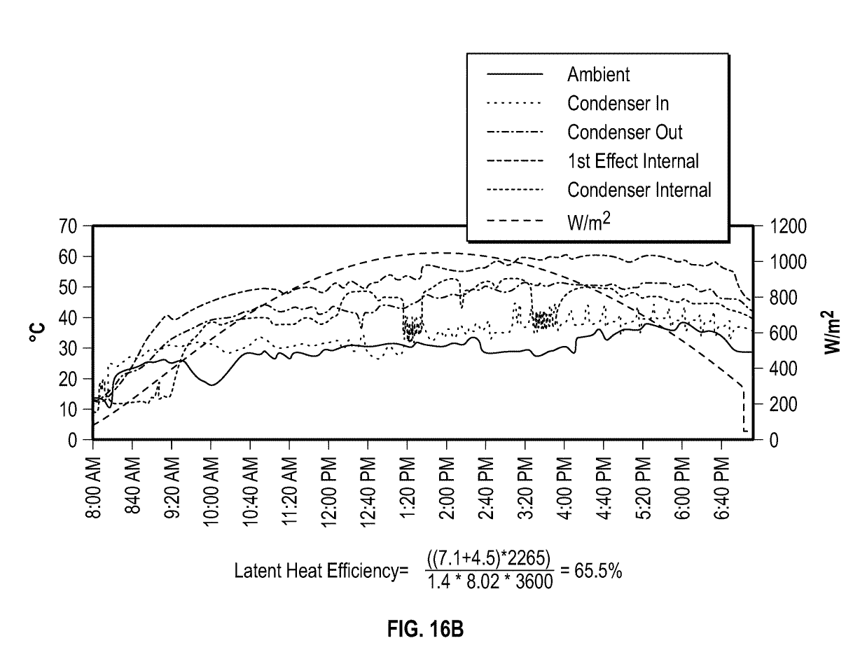

FIGS. 11A-11B illustrate graphs indicative of sample day-cycle performance (April 4), in accordance with an example embodiment. FIGS. 12A-12B illustrate graphs indicative of sample day-cycle performance (April 6), in accordance with an example embodiment. FIGS. 13A-13B illustrate graphs indicative of sample day-cycle performance (April 11), in accordance with an example embodiment. FIGS. 14A-14B illustrate graphs indicative of sample day-cycle performance (April 19), in accordance with an example embodiment. FIGS. 15A-15B illustrate graphs indicative of sample day-cycle performance (April 26), in accordance with an example embodiment. FIGS. 16A-16B illustrates graphs indicative of sample day-cycle performance (April 27), in accordance with an example embodiment.

The disclosed embodiments are particularly suited to producing fresh or potable water from sea water and other salty waters, such as those in desert and semi-desert areas, as examples. Such embodiments and variations thereof are applicable in many other areas as well. The disclosed embodiments can be implemented to provide large quantities of water from salty water to supply irrigation, industrial, and municipal water by using inexpensive material already widely available at low costs throughout the world with minimal energy required and simple operation and upkeep.

As indicated earlier, attempts have been made in the past to provide solar stills capable of producing relatively large quantities of potable water. These attempts have proven to be costly and inefficient and have failed at producing large quantities of potable water. Other desalination technology is complex, energy intensive, and delivers only low yield from feed water. Therefore, a need exists for an improved solar collection system combined with thermal distillation.

One objective of the disclosed embodiments is utilization of the abundance of solar energy to address water demands in desert and semi-desert regions. Another objective is to meld solar energy collection and thermal distillation processes to produce high quality water in quantity for domestic, community, and industrial needs.

In an example embodiment, a process for desalination can be implemented, which utilizes a solar still. Such a solar still can be configured to include a first end and an opposite second end, with the longitudinal axis extending between the ends, and a raised side and an opposite lowered side, with the width axis extending between the sides. The solar still can further include a heating surface being inclined along a direction aligned with or parallel to a width so that the water flows down the heating surface along or parallel with the width axis. The solar still also includes at least one solar-transmitting roof top to admit solar energy to the equipment. The solar still includes at least one tubular member extending below the heating surface between the sides. The solar still includes at least one collection trough positioned to receive condensed water dripping from the tubular member.

The solar still may also include a liquid distributor positioned along the raised side of the heating surface to distribute water discharged from the distributor substantially across the length of the heating surface so that the water flows down the heating surface along or parallel with the width axis. Some non-limiting examples of solar stills are described in U.S. Pat. No. 8,088,257, issued Jan. 3, 2012, U.S. Pat. No. 8,580,085 issued Nov. 12, 2013, and Australian Patent 2008317021 issued Aug. 9, 2012, the disclosures of which are respectively incorporated herein by reference in their entirety. Note that such examples are not considered limiting features of the disclosed embodiments, but are mentioned for illustrative and exemplary purposes only.

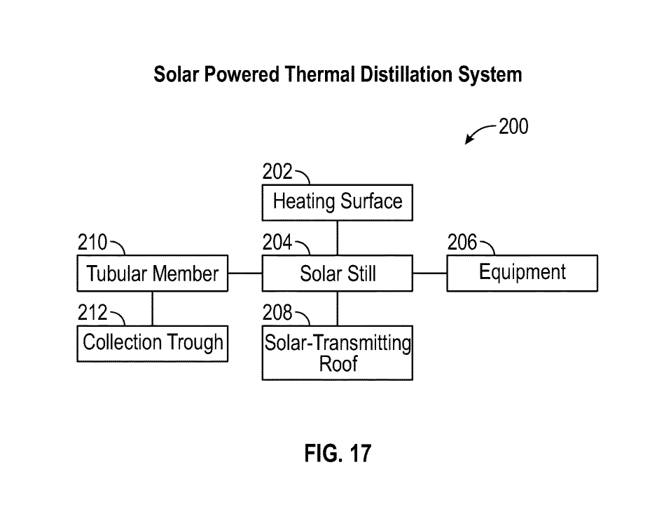

FIG. 17 illustrates a block diagram of a solar powered thermal distillation system 200, which may be implemented in accordance with an example embodiment. The configuration shown in FIG. 17 is presented herein to illustrate the general principals of an example solar powered thermal distillation system. The system 200 depicted in FIG. 17 includes a solar still 204 (similar to the previously discussed solar stills) having a first end and an opposite second end with a longitudinal access extending between the first end and the opposite second end, the solar still further having a raised side and an opposite lowered side with a width axis extending between the raised side and the opposite lowered side (as discussed previously). The system 200 further includes a solar-transmitting roof 208, which can be located atop the solar still 204, such that the solar-transmitting roof 208 admits solar energy to electrical and/or electromechanical equipment 206 maintained within the solar still 204. The solar still 204 can be configured to further include a heating surface 202 that is inclined along a direction aligned with or parallel to the width axis so that water flows down the heating surface 202 along or parallel with the width axis (as also discussed previously). The solar still 204 can be configured to further include a tubular member 210 that extends below the heating surface 202 between the aforementioned raised side and the opposite lowered side. The solar still 204 additionally can be configured to include one or more collection trough(s) 212 positioned to receive condensed water dripping from the tubular member 210.

Note that in one example embodiment, energy recovered in the solar still in the form of heated water may be delivered to a vessel that is operated under vacuum. The vacuum vessel may include one or more elongated tubular member and a trough to collect condensate dripping from the tubular member. Additionally, in some example embodiments, the vacuum vessel may optimally be enclosed in another vessel which enclosing vessel may also be maintained under vacuum conditions. Water from the interior vessel which does not flash may be transferred to another vessel operated at a greater vacuum for further flashing. The flows from one stage to the next may be regulated by use of various measurement and control devices used to stabilize operations and optimize performance.

One pair of internal and external containment vessels with tubular member and trough to recover condensed water constitutes one stage/effect and multiple stages/effects, each with greater vacuum or temperature, can be combined to produce additional pure water at each of the multiple stages/effects. Water heated in the multiple stages/effects can be used to condense flashed water vapor in the earlier, hotter stages and routed through the solar still to the first stage. Additionally, cold water heated in the tubular member of some stages can be stored in vessel which has a transparent canopy with sloped roof. The canopy can include troughs to collect purified water which may form on the interior sloped roof of the canopy and drip into the troughs. The unevaporated water in the vessel under the canopy may optimally be cooled sufficiently to be used as cold water in one or more of the multiple stage flash tubular members.

In some example embodiments, other sources of low temperature energy can be used to add thermal energy to the system. These sources might include low pressure steam, hot boiler blowdown, hot process streams, or other sources incident to the equipment.

In other example embodiments, the system vacuum may be maintained by the use of a direct condensation of the vapor from the final stage in an elevated tank using cold water to condense the vapor. The system vacuum may be maintained using various mechanical devices, educators, or other devices designed to create vacuum.

The disclosed solar distillation system is especially suited to producing fresh or potable water from sea water in west coast deserts in the rain shadow created by cold ocean currents offshore (e.g., the Sahara, Namibia, Australia, et al.). The disclosed embodiments are applicable in many other areas as well. The disclosed embodiments may be implemented, for example, to provide large quantities of water from salty water to supply irrigation, industrial, and municipal water by using inexpensive material already widely available at low costs throughout the world with minimal energy required and simple operation and upkeep.

It will be appreciated that variations of the above-disclosed and other features and functions, or alternatives thereof, may be desirably combined into many other different systems or applications. It will also be appreciated various presently unforeseen or unanticipated alternatives, modifications, variations or improvements therein may be subsequently made by those skilled in the art, which are also intended to be encompassed by the following claims.

What is claimed is:

1. A solar powered thermal distillation system, comprising:
a solar still having a first end and an opposite second end with a longitudinal access extending between said first end and said opposite second end, said solar still further having a raised side and an opposite lowered side with a width axis extending between said raised side and said opposite lowered side;
at least one solar-transmitting roof atop said solar still, wherein said at least one solar-transmitting roof admits solar energy to electrical and/or electromechanical equipment maintained within said solar still;
said solar still further comprising a heating surface inclined along a direction aligned with or parallel to said width axis so that water flows down said heating surface along or parallel with said width axis;
said solar still including a tubular member extending below said heating surface between said raised side and said opposite lowered side; and
said solar still having at least one collection trough positioned to receive condensed water dripping from said tubular member.

2. The system of claim 1 wherein said solar still further comprises a liquid distributor positioned along said raised side of said heating surface to distribute water discharged from said liquid distributor substantially across a length of heating.

3. The system of claim 1 wherein energy recovered in said solar still in a form of heated water is delivered to a vessel operated under a vacuum.

4. The system of claim 3 wherein said vessel includes said tubular member and said at least one collection trough to collect condensate dripping from said at least one tubular member.

5. The system of claim 3 wherein said vessel is enclosed within an exterior vessel that is also maintained under a vacuum condition such that said vessel comprises an interior vessel maintained within said exterior vessel.

6. The system of claim 5 wherein water that does not flash is transferred to another vessel operated at a greater vacuum for further flashing.

7. The system of claim 5 wherein said interior and exterior vessels comprise a pair of internal and external containment vessels in association with said tubular member and said at least one collection trough to recover condensed water, wherein said pair of internal and external containment vessels constitute a one stage/effect and multiple stages/effects, each with greater vacuum or temperature, which are combinable to produce pure water at each of said multiple stages/effects.

8. The system of claim 7 wherein water heated in said multiple stages/effects is used to condense flashed water vapor in earlier and hotter stages and routed through said solar still to a first stage.

9. The system of claim 7 wherein cold water heated in said tubular member is storable in said vessel, wherein said vessel includes a transparent canopy with sloped roof.

10. The system of claim 9 wherein said transparent canopy comprises a plurality of troughs for collecting purified water.

11. A solar powered thermal distillation system, comprising:
a solar still having a first end and an opposite second end with a longitudinal access extending between said first end and said opposite second end, said solar still further having a raised side and an opposite lowered side with a width axis extending between said raised side and said opposite lowered side;
at least one solar-transmitting roof atop said solar still, wherein said at least one solar-transmitting roof admits solar energy to electrical and/or electromechanical equipment maintained within said solar still; and
said solar still further comprising a heating surface inclined along a direction aligned with or parallel to said width axis so that water flows down said heating surface along or parallel with said width axis.

12. The system of claim 11 wherein:
said solar still further comprises a tubular member extending below said heating surface between said raised side and said opposite lowered side; and
said solar still comprises at least one collection trough positioned to receive condensed water dripping from said tubular member.

13. The system of claim 11 wherein said solar still further comprises a liquid distributor positioned along said raised side of said heating surface to distribute water discharged from said liquid distributor substantially across a length of heating.

14. The system of claim 12 wherein energy recovered in said solar still in a form of heated water is delivered to a vessel operated under a vacuum and wherein said vessel includes said tubular member and said at least one collection trough to collect condensate dripping from said at least one tubular member.

15. The system of claim 12 wherein said vessel is enclosed within an exterior vessel that is also maintained under a vacuum condition such that said vessel comprises an interior vessel maintained within said exterior vessel and wherein water that does not flash is transferred to another vessel operated at a greater vacuum for further flashing.

16. A method of configuring a solar still for solar powered thermal distillation, said method comprising:
configuring a solar still with a first end and an opposite second end with a longitudinal access extending between said first end and said opposite second end, said solar still further having a raised side and an opposite lowered side with a width axis extending between said raised side and said opposite lowered side;
providing at least one solar-transmitting roof atop said solar still, wherein said at least one solar-transmitting roof admits solar energy to electrical and/or electromechanical equipment maintained within said solar still;
configuring solar still with a heating surface inclined along a direction aligned with or parallel to said width axis so that water flows down said heating surface along or parallel with said width axis;
modifying said solar still to include a tubular member extending below said heating surface between said raised side and said opposite lowered side; and
providing said solar still with at least one collection trough positioned to receive condensed water dripping from said tubular member.

17. The method of claim 16 further comprising configuring said solar still with a liquid distributor positioned along said raised side of said heating surface to distribute water discharged from said liquid distributor substantially across a length of heating, wherein energy recovered in said solar still in a form of heated water is delivered to a vessel operated under a vacuum.

18. The method of claim 17 wherein said vessel includes said tubular member and said at least one collection trough to collect condensate dripping from said at least one tubular member.

19. The method of claim 17 wherein said vessel is enclosed within an exterior vessel that is also maintained under a vacuum condition such that said vessel comprises an interior vessel maintained within said exterior vessel.

20. The method of claim 5 further comprising configuring said interior and exterior vessels to include a pair of internal and external containment vessels in association with said tubular member and said at least one collection trough to recover condensed water, wherein said pair of internal and external containment vessels constitute a one stage/effect and multiple stages/effects, each with greater vacuum or temperature, which are combinable to produce pure water at each of said multiple stages/effects.
